(19) United States
(12) Patent Application Publication
(10) Pub. No.: US 2024/0397469 A1
(43) Pub. Date: Nov. 28, 2024

(54) POSITIONING MEASUREMENT AND INTERRUPTION EVENTS

(71) Applicant: Sony Group Corporation, Tokyo (JP)

(72) Inventors: Basuki PRIYANTO, Lund (SE); Yujie ZHANG, Lund (SE)

(21) Appl. No.: 18/691,397

(22) PCT Filed: Sep. 20, 2022
(86) PCT No.: PCT/EP2022/076079

§ 371 Date: Mar. 12, 2024

(30) Foreign Application Priority Data
Sep. 30, 2021 (SE) 2151204-1

(51) Int. Cl. H04W 64/00; H04L 5/00; H04W 24/08; H04W 72/0457

(52) U.S. Cl. CPC H04W 64/00; H04L 5/0051; H04W 24/08; H04W 72/0457

(57) ABSTRACT

A method of operating a wireless communication device is disclosed. The method comprises, during a positioning measurement period for performing a positioning measurement, monitoring for positioning signals transmitted by a cellular network and in response to an interruption event halting said monitoring for the positioning signals. The method further comprises, in response to said halting of the monitoring, taking one or more actions associated with the interruption event.

### TECHNICAL FIELD

Various examples of the disclosure generally relate to positioning of wireless communication devices based on positioning signals. Various examples specifically relate to, during a respective positioning measurement period, halting of monitoring for the positioning signals in response to an interruption event.

### BACKGROUND

To facilitate positioning of wireless communication devices (sometimes also referred to as user equipment, UE), multilateration and multiangulation techniques can be employed. An example of multiangulation is triangulation. Here, multiple access nodes (ANs, may be also referred to as base stations, BSs, in a cellular network, NW)—having a well-defined position in a reference coordinate system-transmit positioning signals (also referred to as positioning reference signals, PRSs). A UE can receive the PRSs and then trigger a multilateration or multiangulation. One particular technique is observed time-difference of arrival (OTDOA).

OTDOA is, in particular, deployed in Third Generation Partnership (3GPP) cellular networks, such as the Long Term Evolution (LTE) 4G or New Radio (NR) 5G protocols. Here, the UE receives PRSs from multiple ANs and then performs a timing difference of arrival (TDOA) measurement. Results of the TDOA measurements (e.g., Reference Signal Time Difference, RSTD, measurement) are transmitted from the UE to a location server (LS), such as Location Management Function (LMF) in a 5G network, using a positioning protocol (PP). This is via the 3GPP radio access network (RAN). The LS then performs the positioning estimation based on multilateration and/or multiangulation of at least two or at least three results of the TDOA measurements. See 3GPP Technical specification (TS) 36.305, V15.0.0 (2018 July), section 4.3.2 and/or TS 38.305, V16.0.0 (2020 March), section 4.3.3.

Positioning of the UE may involve two main steps: positioning measurements and position estimate. The positioning measurements may be executed by the UE or by the AN (e.g., a gNB, next generation NodeB). The positioning measurements produce positioning data; the positioning estimate is determined based on the positioning data. A measurement report can include the positioning data. In cases of UE-assisted positioning, the LS performs the positioning estimation. In cases of UE-based positioning, the UE performs both the positioning measurements and the positioning estimation.

In the legacy NR positioning procedure, the positioning measurements are performed in a dedicated measurement gap (MG) during which the UE only performs positioning measurements and is expected not to process any other signals, such as downlink (DL) signal and/or DL channel including Physical Downlink Shared Channel (PDSCH) for DL data and Physical Downlink Control Channel (PDCCH) for DL control channel.

FIG. 1 is a signaling diagram depicting legacy UE-assisted DL-based positioning of a UE. FIG. 1 illustrates aspects with respect to a legacy PP. The UE initially receives a message on the PDSCH which includes LTE PP (LPP) Location Information Request. After decoding and obtaining the location information request, the UE sends an MG request on the Physical Uplink Shared Channel (PUSCH) as an RRC (Radio Resource Control) message to the serving AN. After obtaining the information, the AN provides MG configuration on the PDSCH as an RRC message. After decoding/obtaining the information, the UE receives or measures periodic DL PRSs from typically multiple ANs within the MG. The UE is expected to receive PRSs for at least one positioning occasion (PO) within the MG. Then, the UE also performs positioning measurement, e.g., an RSRP (Reference Signal Received Power) measurement or an RSTD (Reference Signal Time Difference) measurement. Once the measurement is completed and ready to be reported to the LS, the UE transmits an uplink (UL) request in a PUCCH (Physical Uplink Control Channel) to the serving AN. After decoding/obtaining the information, the serving AN provides an UL grant in a PDCCH to the UE. Finally, the UE transmits the positioning measurement results in a PUSCH as the LPP protocol to the LS via the serving AN.

Such techniques face certain restrictions and drawbacks. For example, 3GPP Release 17 proposed new requirements of positioning of UE, which aim for low latency and high accuracy positioning. In general, positioning latency includes physical layer latency and higher layer latency and the physical layer latency is usually the main contributor to the overall positioning latency. In DL-based positioning shown in FIG. 1, the physical layer latency is defined by the time span from the transmission of the PDSCH carrying the location information request and until successfully decoding of the PUSCH carrying the positioning measurement results. I.e., the physical layer latency comprises the time used for PRSs transmission and reception.

For some commercial use cases, such as IIoT (Industrial Internet of Things), the target positioning latency requirement defined by 3GPP Release 17 is that an end-to-end (i.e., overall) latency and a physical layer latency at the UE are smaller than 100 ms and 10 ms, respectively. Especially, for IIoT use cases, the end-to-end latency is desired to be tens of ms, e.g., 30, 40, 70, or 80 ms. However, based on the positioning evaluation, the estimated minimum physical layer latency for 3GPP Release16 DL-based positioning is larger than 100 ms in most of the test cases if more than 4 PRS are received and used for measurements. Accordingly, the legacy positioning procedure latency is exceeding the requirement of physical layer latency of and/or end-to-end latency of NR positioning, for example, according to 3GPP Release 17.

### SUMMARY

Therefore, a need exists for advanced techniques of positioning of a UE. In particular, a need exists for advanced techniques of low-latency positioning which overcome or mitigate at least some of the above-identified restrictions or drawbacks.

This need is met by the features of the independent claims. The features of the dependent claims define examples.

A method of operating a wireless communication device is provided. The method comprises, during a positioning measurement period for performing a positioning measurement, monitoring for positioning signals transmitted by a cellular network and in response to an interruption event, halting said monitoring for the positioning signals. The method further comprises, in response to said halting of the monitoring, taking one or more actions associated with the interruption event.

A computer program or a computer-program product or a computer-readable storage medium includes program code to be executed by at least one processor. Executing the program code causes the at least one processor to perform a method of operating a wireless communication device. The method comprises, during a positioning measurement period for performing a positioning measurement, monitoring for positioning signals transmitted by a cellular network and in response to an interruption event, halting said monitoring for the positioning signals. The method further comprises, in response to said halting of the monitoring, taking one or more actions associated with the interruption event.

A wireless communication device includes control circuitry, the control circuitry being configured to: during a positioning measurement period for performing a positioning measurement, monitor for positioning signals transmitted by a cellular network and in response to an interruption event, halt said monitoring for the positioning signals. The control circuitry is further configured to: in response to said halting of the monitoring, take one or more actions associated with the interruption event.

A method of operating a node of a cellular network is provided. The method comprises, during a positioning measurement period for performing a positioning measurement by a wireless communication device, transmitting an interruption signal to the wireless communication device. The interruption signal causes an interruption event at the wireless communication device, and the interruption event causes the wireless communication device to halt monitoring for positioning signals transmitted by the cellular network.

A computer program or a computer-program product or a computer-readable storage medium includes program code to be executed by at least one processor. Executing the program code causes the at least one processor to perform a method of operating a node of a cellular network. The method comprises, during a positioning measurement period for performing a positioning measurement by a wireless communication device, transmitting an interruption signal to the wireless communication device. The interruption signal causes an interruption event at the wireless communication device, and the interruption event causes the wireless communication device to halt monitoring for positioning signals transmitted by the cellular network.

A network node includes control circuitry, the control circuitry being configured to: during a positioning measurement period for performing a positioning measurement by a wireless communication device, transmit an interruption signal to the wireless communication device. The interruption signal causes an interruption event at the wireless communication device, and the interruption event causes the wireless communication device to halt monitoring for positioning signals transmitted by the cellular network.

For example, the network node could be a location server or one of the one or more access nodes (or base stations).

In a further example, the positioning measurement period is outside of a measurement gap configured for positioning measurements.

In another example, the interruption event comprises at least one of reception of signaling from the cellular network to switch a bandwidth part of a carrier, performing a bandwidth part switching, reception of system information from the cellular network, reception of a reference signal from the cellular network, and reception of high-priority application data from the cellular network.

In a further example, the halting of the monitoring for the positioning signals comprises at least one of the following: temporarily suspending and resuming said monitoring for the positioning signals before and after said taking one or more actions associated with the interruption event, respectively, aborting the monitoring for the positioning signals, discarding positioning data of the positioning measurement acquired until said aborting, and providing, to the cellular network, a partial measurement report comprising positioning data of the positioning measurement acquired until said aborting. In a still further example, said halting of said monitoring is selectively executed depending on a priority level of the interruption event.

It is to be understood that the features mentioned above and those yet to be explained below may be used not only in the respective combinations indicated, but also in other combinations or in isolation without departing from the scope of the disclosure.

### BRIEF DESCRIPTION OF THE DRAWINGS

FIG. 1 is a signaling diagram according to the prior art.

FIG. 2 schematically illustrates aspects of BWPs according to various examples.

FIG. 3 schematically illustrates aspects of BWP switching according to various examples.

FIG. 4 schematically illustrates aspects of positioning measurements performed in a positioning measurement period outside of an MG and interrupted by an interruption event.

FIG. 5 schematically illustrates a cellular network according to various examples.

FIG. 6 schematically illustrates a resource mapping of various channels implemented on a wireless link of the cellular network according to various examples.

FIG. 7 schematically illustrates transmission of PRSs according to various examples.

FIG. 8 schematically illustrates a BS according to various examples.

FIG. 9 schematically illustrates a UE according to various examples.

FIG. 10 schematically illustrates an LS according to various examples.

FIG. 11 is a flowchart of a method according to various examples.

FIG. 12 is a flowchart of a method according to various examples.

FIG. 13 is a signaling diagram according to various examples.

### DETAILED DESCRIPTION

Some examples of the present disclosure generally provide for a plurality of circuits or other electrical devices. All references to the circuits and other electrical devices and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microcontrollers, a graphics processor unit (GPU), integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, any one or more of the electrical devices may be configured to execute a program code that is embodied in a non-transitory computer readable medium programmed to perform any number of the functions as disclosed.

In the following, examples of the invention will be described in detail with reference to the accompanying drawings. It is to be understood that the following description of examples is not to be taken in a limiting sense. The scope of the invention is not intended to be limited by the examples described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Hereinafter, techniques which facilitate positioning of UEs are described. Positioning allows determining the geographic position and/or velocity of the UE based on measuring PRSs. Position estimates of the UE may be requested by and reported to a client (e.g., an application) associated with the UE, or by a client within or attached to a core network of a cellular NW. The position estimates may be reported in standard formats, such as those for cell-based or geographical co-ordinates, together with estimated errors (uncertainty) of the position and velocity of the UE and, if available, the positioning method (or the list of the methods) used to obtain the position estimate.

There are many different possible uses for position estimates. The positioning estimates may be used internally by communication systems, such as LTE systems or 5G systems, by value-added network services, by the UE itself or through the network, and by “third party” services. The functions may also be used by an emergency service (which may be mandated or “value-added”), but the location service is not exclusively for emergencies.

The techniques disclosed herein disclose aspects with respect to a PP that facilitates positioning at low latency. The PP provides for a framework to facilitate low-latency positioning measurements.

The techniques described herein generally rely on the transmission of PRSs. Various implementations of PRSs are conceivable. For example, PRSs may be transmitted in in the DL or in the UL. According to the disclosure, DL-based positioning and/or UL-based positioning can be used.

For DL positioning: The PRSs are transmitted by multiple ANs (e.g., gNBs for 3GPP NR) and can be received by a target UE to be positioned. On the other hand, for the UL positioning, the UL reference signals—e.g., sounding reference signals (SRSs)—are transmitted by the target UE to be positioned and can be received by multiple ANs. The PRSs and the SRSs can both be called positioning signals or reference signals in this disclosure and the DL PRSs and generally DL positioning will be used as an example to describe this disclosure hereinafter, but similar techniques may also be applicable to UL positioning.

According to various examples described herein, transmission of the PRSs may be implemented on a wireless link on which also transmission of further signals is implemented. In particular, the further signals may encode, e.g., control messages or payload messages. The wireless link may operate according to a transmission protocol. For example, the transmission protocol may employ Orthogonal Frequency Division Multiplex (OFDM) modulation. Here, a carrier comprises multiple subcarriers and one or more associated time-frequency resource grids are defined. For example, the transmission protocol may be associated with a RAN of a cellular network; here, the ANs can be implemented by ANs of the RAN.

According to the various techniques described herein, the positioning may employ a multilateration and/or multiangulation technique based on one or more receive properties of the PRSs transmitted by multiple ANs. It would be possible that the logic for implementing said positioning—i.e., determining the position estimate-partly or fully resides at the UE to be positioned, and/or partly or fully resides at an LS, e.g., implemented by an LMF. For example, it would be possible that the UE reports raw measurement data associated with the one or more receive properties of the PRSs to the LS and that the multilateration and/or multiangulation is implemented at the LS. It would also be possible that at least a part of the processing of the multilateration and/or multiangulation etc. is implemented at the UE.

The ANs can have a well-defined position within a reference coordinate system and the target UE can be positioned within the reference coordinate system.

The positioning method used herein may generally comprise OTDOA, DL-AOD (Downlink Angle-of-Departure), DL-TDOA (Downlink Time Difference of Arrival), UL-AoA (Uplink Angle-of-Arrival), UL-TDOA (Uplink Time Difference of Arrival), Multi RTT (Round Trip Time).

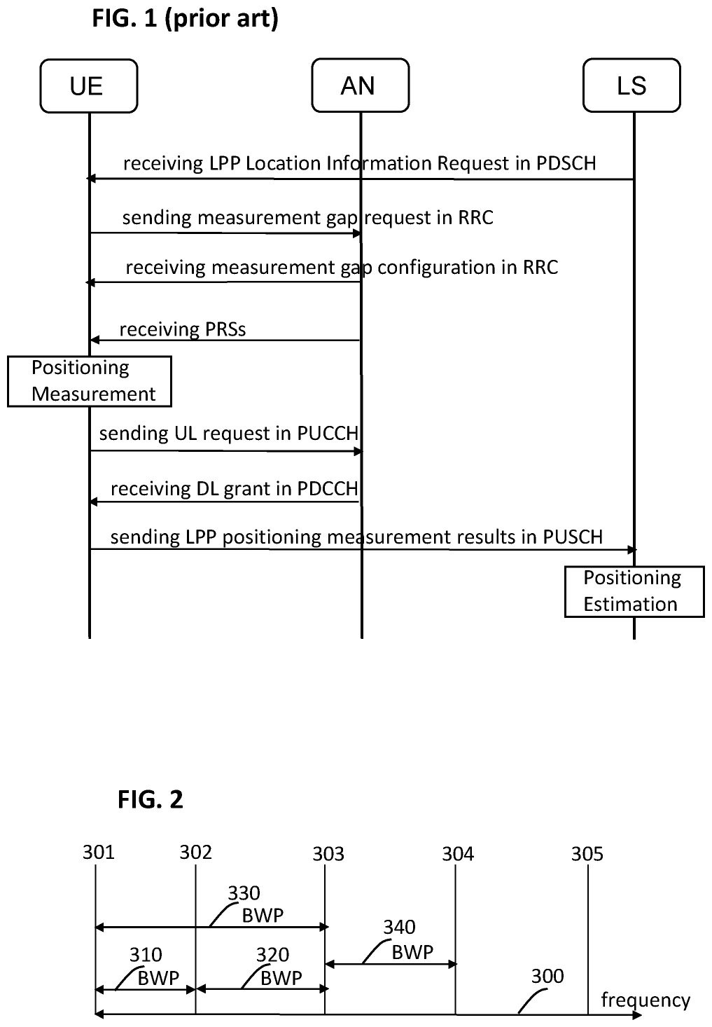

According to various examples of this disclosure, in contrast to positioning measurements performed inside of/within a MG, positioning measurements may be performed during a positioning measurement period outside of an MG configured/dedicated for positioning measurements, in which there may not be UE specific operations on performing positioning MG. For example, the positioning measurements may be performed according to a positioning procedure without any MG, i.e., no MG is requested by a UE and is granted by a serving AN. Thus, at least steps with respect to requesting an MG and granting configuration of an MG, as shown in FIG. 1, may not be needed and thereby the physical layer latency can be reduced. In another example, the positioning measurements may be performed according to a positioning procedure with MGs—i.e., there is a general capability to schedule MGs—but for some specific instances, e.g., low latency use cases, positioning measurements may be performed without requesting and granting an MG. On the other hand, for other instances, which may need, for example, an uninterrupted positioning measurement, positioning measurements may be performed within an MG, i.e., according to a positioning procedure with requesting and granting an MG, such as the legacy positioning procedure. Therefore, the positioning measurement may be performed in a dedicated MG to avoid interruption. In summary, there may be, for example, a first type of positioning procedure which only supports positioning measurements within an MG, such as the legacy ones, or a second type of positioning procedure which only supports positioning measurements without an MG, or a third type of positioning procedure which supports positioning measurements both inside of and outside of an MG. As used herein, the terminology “outside of an MG” comprises positioning measurements without an MG according to the second type of positioning procedure and positioning measurements outside of an MG according to the third type of positioning procedure.

Various techniques are based on the finding that performing a positioning measurement during a positioning measurement period outside of a MG can lead to conflicts with other tasks or actions, e.g., reception of data, frequency switching, etc. According to various examples, it is possible to halt monitoring for positioning signals in response to an interruption event when performing a positioning measurement during a positioning measurement period outside of a MG. It is then possible to take one or more actions associated with the interruption event, such one or more actions otherwise being in conflict with said monitoring for the positioning signals.

According to the various techniques described herein, performing positioning measurements during a positioning measurement period outside of an MG may be in accordance with respective capabilities of a UE. For example, the UE may be required to be capable of determining a priority of performing the positioning measurements relative to all other DL signals/channels received during the positioning measurement period. The UE may determine that the positioning measurement has the highest priority based on, for example, information indicated by a location information request, i.e., the positioning measurement may not be halted by any one of all other DL signals/channels received during the positioning measurement period. Alternatively, the UE may determine that the positioning measurement has a lower priority over one or more other DL signals/channels received during the positioning measurement period. The one or more other DL signals/channels may be component-carrier-specific, and/or frequency-band-specific, and/or cell-specific, e.g., serving-cell-(gNB-) specific or neighboring-cell-(neighboring-gNBs-) specific. The one or more other DL signals/channels may comprise an indication that the one or more other DL signals/channels have a higher priority than that of the positioning measurement. Additionally or optionally, the UE may need to be able to provide, to the cellular network, such as to a serving BS and/or to an LS, its abilities to perform positioning measurements during a positioning measurement period outside of an MG, e.g., in procedures related to assistance data transfer defined in 3GPP specifications, such as 3GPP TS 37.355 version 16.2.0 Release 16, Section 5.2. The capabilities of a UE may comprise at least one of the following: whether the UE can determine prioritization of the positioning measurements over other DL signals/channels received in the positioning measurement period; and/or whether the UE can perform positioning measurements both inside of and outside of an MG. Additionally or optionally, the UE may need to be capable of sending, to higher layers, such as layer 2 and/or layer 3 (according to an Open System Interface, OSI, scheme or specifically according to 3GPP NR specification), an indication of performing positioning measurements during a positioning measurement period outside of an MG. In case the higher layer(s) have a conflict with the performing of the positioning measurements, the UE may receive, from corresponding layers, signaling indicating the conflict. Then, the UE may postpone or abort the performing of the positioning measurements.

As a general rule, performing positioning measurements outside of an MG may be interrupted by an interruption event, such as signaling/instruction received from a wireless/cellular network, e.g., a serving gNB or an LS, or from the UE. For example, the signaling/instruction may comprise those for control and/or for data in the physical layer, as respectively specified in 3GPP TS 38.213 version 16.6.0 Release 16 and 3GPP TS 38.214 version 16.6.0 Release 16.

Various exemplary interruption events according to this disclosure are illustrated in TAB. 1 below.

TABLE 1
Exemplary interruption events.

| Interruption | | | Predefined/ |
|---|---|---|---|
| event | Interruption event | Priority level (0 > 1 > | estimated |
| index | (candidate) | 2 > 3 > 4 > . . . ) | duration |
| E1 | reception of signaling | 1 | d1 |
| | from the cellular network | | |
| | to switch a bandwidth | | |
| | part of a carrier | | |
| E2 | performing a bandwidth | 1 | d2 |
| | part switching | | |
| E3 | reception of system | 2 (may depend on a specific | d3 |
| | information from the | type of the received system | |
| | cellular network | information) | |
| E4 | reception of a reference | 3 (may depend on a specific | d4 |
| | signal from the cellular | type of the received reference | |
| | network | signal) | |
| E5 | reception of application | 4 (may depend on a specific | d5 |
| | data from the cellular | application) | |
| | network | | |

TAB. 1 shows interruption events E1-E5. TAB. 1 also illustrates examples for relative priority levels of the various interruption events. Each interruption event can include a respective preconfigured priority level. For instance, it would be possible to selectively consider an interruption event, depending on the priority level. Further, TAB. 1 also illustrates an estimated duration of the interruption events. According to various examples, it would be possible to selectively consider an interruption event, depending on the estimated duration. The priority levels and the estimated durations are generally optional.

During a positioning measurement period outside of an MG for performing a positioning measurement, the positioning measurement may be interrupted by at least one of the interruption events E1-E5. Each of the interruption events E1-E5 may have a priority level, such as any one of 0-4, among which 0 indicates the highest priority level and 4 indicates the lowest priority level. Alternatively or optionally, the priority level associated with each of the interruption events E1-E5 may rely on a type of a specific signal/data/application/information, as shown in TAB. 1. Additionally or optionally, each of the interruption events E1-E5 may comprise a predefined/estimated duration, such as one of d1-d5. For example, such a duration may be predefined by corresponding 3GPP technical specifications or estimated by the wireless network, such as, a serving BS or an LS, or by the UE.

According to various examples, during a positioning measurement period outside of an MG for performing a positioning measurement, the UE may receive signaling from the cellular network to switch a bandwidth part (BWP) of a carrier, i.e., the interruption event E1 of TAB. 1, and thereby the positioning measurement may be interrupted by the interruption event E1. For example, according to 3GPP TS 38.133 version 16.8.0 Release 16, such signaling may comprise at least one of DCI (Downlink Control Information) carried by PDCCH, RRC signaling, signaling trigger by a timer, e.g., the BWP-InactivityTimer, or signaling triggered by the MAC entity.

A BWP is a contiguous set of physical resource blocks (PRBs) on a given carrier, selected from all PRBs of the carrier. The PRBs of the carrier may be numbered from one end through the other end of the carrier band. In either DL or UL, an AN, e.g., a BS, may configure a UE with up to 4 BWPs for each component carrier. Each BWP may have its own bandwidth (BW), frequency allocation, cyclic prefix (CP) length, and numerology, such as, one of 0-3, which respectively indicate different subcarrier spacing (SCS), e.g., 15 kHz, 30 kHz, 60 kHz, or 120 KHz.

FIG. 2 schematically illustrates aspects of BWPs 310, 320, 330, 340 according to various examples. The BWPs 310, 320, 330, 340, respectively, occupy an associated subfraction of the overall bandwidth 300 of a carrier. The BWP 310 includes a sub-BW ranging from PRB 301 to PRB 302. The BWPs 320 and 340 respectively comprise a sub-BW ranging from PRB 302 to PRB 303 and a sub-BW ranging from PRB 303 to PRB 304. The BWP 330 overlaps a combination of BWPs 310 and 320. At least one of the BWPs 310-340 may be configured for a UE and there may be a further BWP including a sub-BW ranging from PRB 304 to PRB 305, which may be configured for the UE or a further UE.

For example, allocation of resource elements of the time-frequency grid for transmission of various signals, including PRSs, can be relatively defined with respect to the respective BWP 310-340. A receiver of a UE, if configured to monitor, e.g., the BWP 310, can limit its receive bandwidth correspondingly. As a general rule, each BWP 310-340 can have a unique OFDM numerology. For instance, the BWP 310 implements a first numerology, such as 0; while the BWP 320 and the BWP 340 implement a second numerology, such as 1.

In general, different BWPs 310-340 may be employed, depending on the payload size and traffic or signal type, for power saving purposes. For example, the UE can use a narrow BWP, such as the BWP 310, for monitoring control channels and only open the full bandwidth of the carrier when a large amount of data is scheduled. Different BWPs 310-340 can also offer flexibility in 5G to provide UE supporting various transmission types, such as eMBB (enhanced Mobile Broadband), URLLC (Ultra Reliable Low Latency Communications), mMTC (massive Machine Type Communications). In further example, the UE can use a narrow BWP, such as the BWP 310, for a low speed data traffic (e.g. mMTC use case), and use a wider BWP, such as BWP 320, for a high-speed data traffic (e.g., eMBB use case). In further example, the UE can use a BWP with a specific numerology, such as BWP 340, for a low latency application (e.g., URLLC) that may have a larger sub-carrier spacing.

BWP configuration signaling may be carried by DCI signaling, by MAC CE (Medium Access Control Coverage Enhancement) signaling, or by dedicated RRC signaling. A UE may have up to four configured BWPs 310-340, but it can only have one active BWP at a given time point. At a given time instant, the UE is expected to receive and transmit within the frequency resources configured for the active BWP with an associated numerology. A serving AN, such as a serving BS, may also indicate the UE to switch to another BWP via DCI or after a period of time, e.g., specified by a timer. By switching between different BWPs, the wireless network can dynamically switch between different frequency bandwidths being utilized for communicating with the different UEs or different channels. Also, by the use of different numerologies in different BWPs, different QoS levels may be achieved due to the numerology relation to the OFDM symbol length.

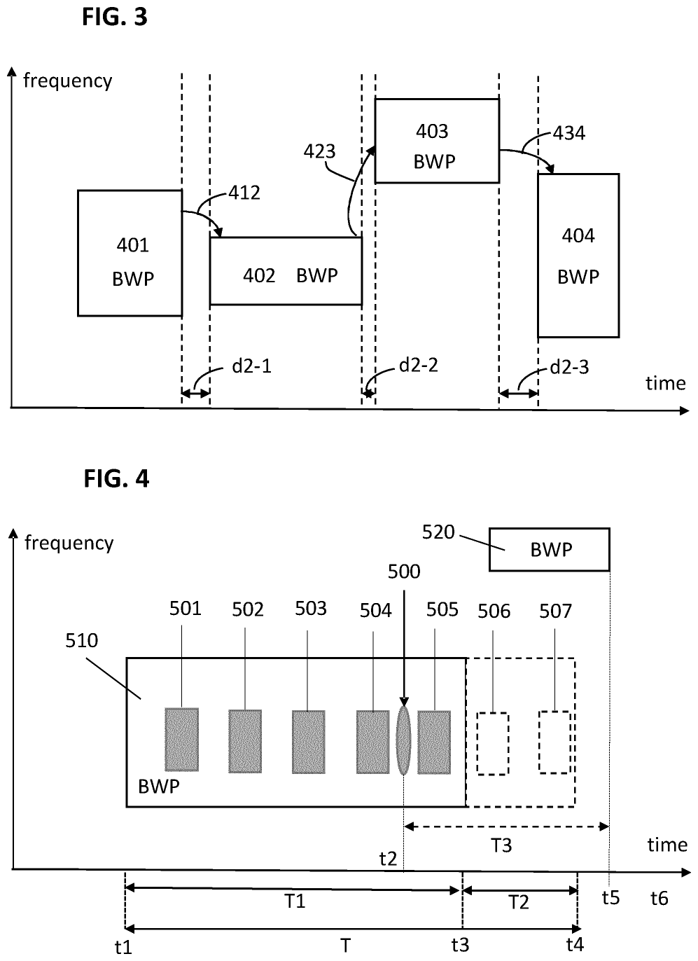

FIG. 3 schematically illustrates aspects of BWP switching (or BWP selection) according to various examples. As explained in connection with TAB. 1, interruption event E2, such BWP switching can be an interruption event triggering a halt of monitoring for PRSs at the UE, and consequently, positioning measurement based on the received PRSs is halted as well.

Upon BWP switching, a specific BWP is selected or configured as the active BWP. For example, as illustrated in FIG. 3, by respectively performing a corresponding BWP switching 412, 423, and 434, the active BWP may be switched respectively from BWP 401, 402, and 403, to BWP 402, 403, and 404. The time duration d2-1, d2-2, and d2-3 for respectively performing the BWP switching 412, 423, and 434 may be predefined by 3GPP technical specification. For example, according to 3GPP TS 38.133 version 16.8.0 Release 16, Table 8.6.2-1: BWP switch delay, such a time duration d1-1, d1-2, and d1-3 may depend on UE capability and the smaller SCS indicated by numerology (u) implemented before and after the BWP switching.

According to various examples, during a positioning measurement period outside of an MG for performing a positioning measurement, the UE may perform a BWP switching (or switch), i.e., the interruption event E2 of TAB. 1, such as one of the BWP switching 412, 423, and 434, and thereby the positioning measurement may be interrupted by the interruption event E2 having a predefined duration d2, such as one of the time duration d2-1, d2-2, and d2-3.

According to further various examples, the interruption event may comprise reception of system information from the cellular network, i.e., the interruption event E3 of TAB. 1. The system information may be received from a node of the cellular network, such as a serving BS. The system information may comprise, according to 3GPP TS 38.331 version 16.5.0 Release 16, clause 5.2, MIB (Master Information Block), a number of SIBs (System Information Blocks) and posSIBs (Positioning SIBs). Additionally or optionally, the reception of system information may comprise reception of system information updates. The reception of system information may be performed based on system information acquisition procedures defined in, for example, 3GPP TS 38.331 version 16.5.0 Release 16. Optionally, the priority level of the interruption event E3 may depend on a specific type of the received system information, i.e., MIB, SIB1, other SIBs, or posSIBs.

According to further various examples, the interruption event may comprise reception of a reference signal from the cellular network, i.e., the interruption event E4 of TAB. 1. The reference signal may be received from a node of the cellular network, such as a serving BS or an LS. The reference signal may comprise at least one of CSI-RS (Channel State Information Reference Signals), TRS (Tracking Reference Signals), DM-RS (Demodulation Reference Signals), PT-RS (Phase Tracking Reference Signals), SRS, and PRS. Optionally, the priority level of the interruption event E4 may depend on a specific type of the received reference signal. The reference signal is different than the PRSs used for the positioning measurement.

Various exemplary reference signals according to this disclosure are illustrated in TAB. 2 below.

TABLE 2
Exemplary reference signals.

| Reference signal | Description |
|---|---|
| CSI-RS | CSI-RS may be downlink reference signals intended to be used |
| | by UEs to acquire downlink channel-state information (CSI). |
| | Specific instances of CSI reference signals can be configured |
| | for time/frequency tracking and mobility measurements. |
| TRS | TRS may be sparse reference signals intended to assist the UE |
| | in time and frequency tracking. A specific CSI-RS configuration |
| | may serve the purpose of a TRS. |
| DM-RS | DM-RS for PDSCH may be intended for channel estimation at |
| | the device as part of coherent demodulation. They may be |
| | present in the resource blocks used for PDSCH transmission. |
| | Similarly, the DM-RS for PUSCH may allow the BS to |
| | coherently demodulate the PUSCH. |
| PT-RS | PT-RS may be seen as an extension to DM-RS for |
| | PDSCH/PUSCH and may be intended for phase-noise |
| | compensation. The PT-RS may be denser in time but sparser in |
| | frequency than the DM-RS, and, if configured, may occur in |
| | combination with DM-RS. |

TAB 2 shows reference signals CSI-RS, TRS, DM-RS, and PT-RS.

Alternatively or additionally, the interruption event may comprise reception of application data from the cellular network, i.e., the interruption event E5 of TAB. 1. Application data could be included in a message communicated on the PDSCH. Application data could originate at a packet network outside of the cellular network. Application data could be defined/native to Layer 3 or higher. The application data may have a higher priority than the positioning measurements, such as application data to support URLLC application, or extended reality (XR) application. Such an application may run on a node connected to the cellular network, such as an LS, a cloud server, an edge server. For illustration, there may be multiple bearers defined on the data connection, each bearer being associated with the respective application. Different bearers can have different priority levels. Then, depending on the priority level of the bearer and, accordingly, the application data, it is possible to selectively halt monitoring for the positioning signals or not, i.e., selectively halt performing positioning measurement.

Alternatively or additionally, the interruption event may comprise reception of application data from the UE to be positioned. The application data may have a higher priority than the positioning measurements. Such an application may run on the UE, such as an emergency service application.

According to various examples, the interruption event may comprise reception of signaling from the cellular network to perform a beam sweeping. The positioning measurement may be performed based on multiple positioning reference signal resources associated with multiple beams. A PRS beam may be referred to as a PRS resource while the full set of PRS beams transmitted from a TRP on the same frequency may be referred to as a PRS resource set.

Various interruption events have been described above in connection with TAB. 1, and in response to the interruption event, the UE may halt the monitoring for the positioning signals and take one or more actions associated with the interruption event. Consequently, the UE may also halt performing positioning measurements.

Various exemplary actions associated with the interruption events E1-E5 shown in TAB. 1 are illustrated in TAB. 3 below.

TABLE 3
Exemplary actions associated with the interruption events.

| Interruption | |
|---|---|
| event index | Actions associated with the interruption event |
| E1 | receiving DCI signaling from the cellular network to switch a BWP of |
| | a carrier; or |
| | receiving signaling associated configuration of the BWP- |
| | InactivityTimer and configuring the BWP-InactivityTimer; or |
| | receiving signaling from the MAC entity. |
| E2 | performing a BWP switching |
| E3 | receiving, from the cellular network, system information, such as |
| | MIB, SIBs, or posSIBs. |
| E4 | receiving, from the cellular network, a reference signal, such as |
| | CSI-RS, TRS, DM-RS, or PT-RS. |
| E5 | receiving, from the cellular network, high-priority application data |

TAB. 3 shows exemplary actions associated with the interruption events E1-E5 shown in TAB. 1.

Irrespective of the specific interruption event, according to various examples, the UE may perform various operations with respect to the positioning measurement in response to the interruption event. In other words, halting said monitoring of the PRSs may be implemented differently in different examples disclosed herein. Various exemplary implementations are illustrated in TAB. 4 below.

TABLE 4
Exemplary operations with respect to the positioning measurement performed during
a positioning measurement period in response to the interruption event and
after taking one or more actions associated with the interruption event.

| | Operations after taking one or more |
|---|---|
| Example implementation of halting said | actions associated with the |
| monitoring of positioning signals | interruption event |
| temporarily suspending the monitoring for the | resuming the monitoring for the |
| positioning signals | positioning signals, i.e., continuing |
| | the positioning measurement |
| aborting the monitoring for the positioning | Optionally performing a further |
| signals | (new) positioning measurement |
| aborting the monitoring for the positioning | |
| signals; and, | |
| discarding (i.e., deleting) positioning data of | |
| the positioning measurement acquired until | |
| the aborting | |
| aborting the monitoring for the positioning | optionally, providing, to the cellular |
| signals, optionally, providing, to the cellular | network, a partial measurement |
| network, a partial measurement report | report comprising positioning data of |
| comprising positioning data of the positioning | the positioning measurement |
| measurement acquired until the aborting, and | acquired until the aborting |
| optionally, discarding positioning data of the | |
| positioning measurement acquired until the | |
| aborting after providing the partial | |
| measurement report | |

FIG. 4 schematically illustrates aspects of positioning measurements performed in a positioning measurement period T ranging from time point t1 to time point t4, outside of an MG and interrupted by an interruption event 500 occurred at time instance t2, e.g., receiving DCI in PDCCH. The BS transmits PRS resources 501-507 and each resource may occupy one or more symbols. The UE can still monitor the symbols between PRS resources, for example, monitoring any potential downlink control channel from the BS. PRS resources 501-507 may be configured for performing the positioning measurements within the positioning measurement period T, however, due to the interruption event 500, the PRS resources 506 and 507 within a time duration T2 cannot be utilized for monitoring for positioning signals transmitted by the cellular network using the PRS resources 506 and 507. I.e., the PRS resources 501-505 within a time duration T1 were used for monitoring for positioning signals transmitted using the PRS resources 501-505 and thereby the positioning measurements may be based on the PRS resources 501-505.

According to various examples, the UE may temporarily suspend the monitoring for the positioning signals in response to the interruption event 500, such as at least one of E1-E5 shown in TAB. 1, and take one or more actions associated with the interruption event 500, e.g., actions associated with the interruption events shown in TAB. 3. Consequently, the UE may also halt performing positioning measurements. After taking the one or more actions associated with the interruption event 500, the UE may resume the monitoring for the positioning signals by using, for example, PRS resources configured within a time duration (t6-t5) from t5 to t6, and thereby resume performing positioning measurements. Optionally or additionally, after monitoring for the positioning signals received within the time duration t6-t5 and performing the positioning measurements, the UE may provide, to the cellular network, a partial measurement report comprising positioning data of the positioning measurement acquired until the aborting, i.e., using PRS resources 501-505 within the time period T1, and positioning data of the positioning measurement acquired during the time duration t6-t5.

According to various examples, the UE may abort the monitoring for the positioning signals in response to the interruption event 500, and take one or more actions associated with the interruption event 500. Consequently, the UE may abort performing positioning measurements. After taking the one or more actions associated with the interruption event 500, the UE may perform a further (or new) positioning measurement by using, for example, PRS resources configured within the time duration t6-t5 after time point t5, and provide, to the cellular network, a measurement report comprising positioning data of the positioning measurement acquired during the time duration t6-t5. Optionally or additionally, after aborting the monitoring for the positioning signals in response to the interruption event 500, the UE may discard positioning data of the positioning measurement acquired until the aborting, i.e., within the time duration T1.

According to various examples, after aborting the monitoring for the positioning signals in response to the interruption event 500, the UE may provide, to the cellular network, a partial measurement report comprising positioning data of the positioning measurement acquired until the aborting, i.e., using PRS resources 501-505 within the time period T1. Optionally or additionally, the UE may then discard positioning data of the positioning measurement acquired until the aborting, i.e., within the time duration T1.

According to various examples, the UE may perform a threshold comparison between a measure of a fraction T1/T of the positioning measurement period elapsed until halting (including temporarily suspending and aborting) and a predefined threshold, depending on a result of the threshold comparison, discard positioning data of the positioning measurement acquired until the aborting or providing, i.e., acquired within T1, to the cellular network, the positioning data. Here, it can be checked whether sufficient positioning data for a reliable position estimate has been measured.

According to various examples, the UE may determine a duration T3 of the interruption event 500, and then selectively abort the positioning measurement or temporarily suspend the positioning measurement depending on the duration T3 of the interruption event 500. For example, if the duration T3 is longer than a predefined threshold, e.g., 10 ms or 20 ms, the UE may abort the positioning measurement and perform a new positioning measurement by using, for example, PRS resources configured within the time duration t6-t5 after time point t5, and provide, to the cellular network, a measurement report comprising positioning data of the positioning measurement acquired during the time duration t6-t5. Accordingly, a low latency can be achieved. On the other hand, if the duration T3 is shorter than the predefined threshold, the UE may temporarily suspend the positioning measurement and resume the monitoring for the positioning signals by using, for example, PRS resources configured within a time duration t6-t5 which is a part of the positioning measurement period t6-t1. Accordingly, the UE may resume performing positioning measurements based on the received positioning signals using the PRS resources configured within the time duration t6-t5.

As a general rule, such threshold comparison could be based on the measured PRSs and/or the time fraction of the positioning measurement duration, as explained above. The threshold could be network-configured or predefined in the communication protocol.

According to various examples, the interruption event may be E2, i.e., performing a BWP switching from a BWP 510 to a BWP 520. If the predefined duration d2 of performing the BWP switching (or, any other type of interruption event) is shorter than the predefined threshold, the UE may resume the monitoring for the positioning signals by using, for example, PRS resources configured within the BWP 520. In a further example, if a new BWP, e.g. BWP 330 of FIG. 2, overlaps with the previous BWP, e.g., BWP 310 or 320 of FIG. 2, the UE may resume the monitoring for the positioning signals by using the exactly the same PRS resources, e.g., the same channel condition, as the previous (narrow) BWP, because the new (wider) BWP includes all of the previous BWP, i.e., the previous BWP is a subset of the new BWP. Optionally or additionally, after monitoring for the positioning signals received using the PRS resources configured within the BWP 520, the UE may provide, to the cellular network, a partial measurement report comprising positioning data of the positioning measurement acquired until the aborting, i.e., using PRS resources 501-505 within the BWP 510, and positioning data of the positioning measurement acquired within the BWP 520.

As will be appreciated from the above, the techniques described in this disclosure utilize a positioning measurement period outside of an MG to perform a positioning measurement by monitoring for positioning signals transmitted by a cellular network. Accordingly, the latency, especially the physical layer latency incurred in performing the positioning measurement can be adjusted by using a positioning measurement period outside of an MG. In addition, when an interruption event happens during the positioning measurement period, the UE can adaptively perform appropriate operations with respect to the positioning measurement in response to the interruption event and after taking one or more actions associated with the interruption event, to mitigate positioning latency and/or positioning accuracy caused by the interruption event. As such, the positioning latency can be balanced against the positioning accuracy. Such techniques may be applied to 5G communication systems and facilitate the performance of such communication systems.

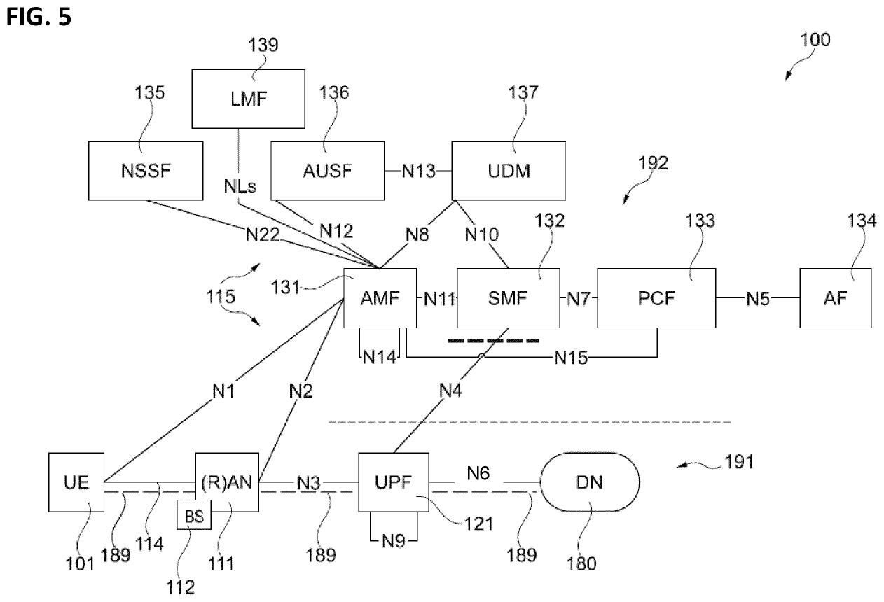

FIG. 5 schematically illustrates a cellular network 100. The example of FIG. 5 illustrates the network 100 according to the 3GPP 5G architecture. Details of the 3GPP 5G architecture are described in 3GPP TS 23.501, version 1.3.0 (2017 September). While FIG. 5 and further parts of the following description illustrate techniques in the 3GPP 5G framework of a cellular network, similar techniques may be readily applied to other communication networks. Examples include e.g., an IEEE Wi-Fi technology.

In the scenario of FIG. 5, a UE 101 is connectable to the cellular network 100. For example, the UE 101 may be one of the following: a cellular phone; a smart phone; and IOT device; a MTC device; a sensor; an actuator; etc.

The UE 101 is connectable to the network 100 via a RAN 111, typically formed by one or more ANs 112 (only a single BS 112 is illustrated in FIG. 5 for the sake of simplicity; the BSs implement ANs). A wireless link 114 is established between the RAN 111—specifically between one or more of the BSs 112 of the RAN 111—and the UE 101. The wireless link 114 is defined by one or more OFDM carriers. The ANs/BSs 112 may transmit, to the UE 101, an interruption event of the interruption events E1-E5 shown in TAB. 1 during a positioning measurement period for performing a positioning measurement by monitoring for positioning signals transmitted by the cellular network 100. In response to receiving the interruption event, the UE may halt the monitoring for the positioning signals and take one or more actions associated with the interruption event. Consequently, the UE may also halt performing positioning measurements.

The RAN 111 is connected to a core network (CN) 115. The CN 115 includes a user plane (UP) 191 and a control plane (CP) 192. Application data is typically routed via the UP 191. For this, there is provided a UP function (UPF) 121. The UPF 121 may implement router functionality. Application data may pass through one or more UPFs 121. In the scenario of FIG. 5, the UPF 121 acts as a gateway towards a data network 180, e.g., the Internet or a Local Area Network. Application data can be communicated between the UE 101 and one or more servers on the data network 180.

The network 100 also includes an Access and Mobility Management Function (AMF) 131; a Session Management Function (SMF) 132; a Policy Control Function (PCF) 133; an Application Function (AF) 134; a Network Slice Selection Function (NSSF) 135; an Authentication Server Function (AUSF) 136; a Unified Data Management (UDM) 137; and a Location Management Function (LMF) 139. FIG. 5 also illustrates the protocol reference points N1-N22 between these nodes.

The AMF 131 provides one or more of the following functionalities: registration management; non-access stratum (NAS) termination; connection management; reachability management; mobility management; access authentication; and access authorization. A data connection 189 is established by the AMF 131 if the respective UE 101 operates in a connected mode.

The SMF 132 provides one or more of the following functionalities: session management including session establishment, modify and release, including bearers set up of UP bearers between the RAN 111 and the UPF 121; selection and control of UPFs; configuring of traffic steering; roaming functionality; termination of at least parts of NAS messages; etc. As such, the AMF 131 and the SMF 132 both implement CP mobility management needed to support a moving UE.

The data connection 189 is established between the UE 101 via the RAN 111 and the data plane 191 of the CN 115 and towards the DN 180. For example, a connection with the Internet or another packet data network can be established. To establish the data connection 189, it is possible that the respective UE 101 performs a random access (RACH) procedure, e.g., in response to reception of a paging indicator or paging message and, optionally, a preceding wake up signal. A server of the DN 180 may host a service for which payload data is communicated via the data connection 189. The data connection 189 may include one or more bearers such as a dedicated bearer or a default bearer. The data connection 189 may be defined on the RRC layer, e.g., generally Layer 3 of the Operating Systems Interconnection (OSI) model of Layer 2. The data connection 189 can carry application data.

The LMF 139 implements an LS. The LMF 139 handles location service requests. This may include transferring assistance data to the target UE 101 to be positioned to assist with UE-based and/or UE-assisted positioning and/or may include positioning of the target UE. See 3GPP TS 38.305 V15.3.0 (2019 March), section 5.1. For DL positioning using PRSs, the LMF 139 may instigate location procedures using a positioning protocol with the UE 101—e.g. to obtain a location estimate or positioning measurements or to transfer location assistance data to the UE 101. The LMF 139 can provide a configuration regarding selective halting of a positioning measurement to the UE 101.

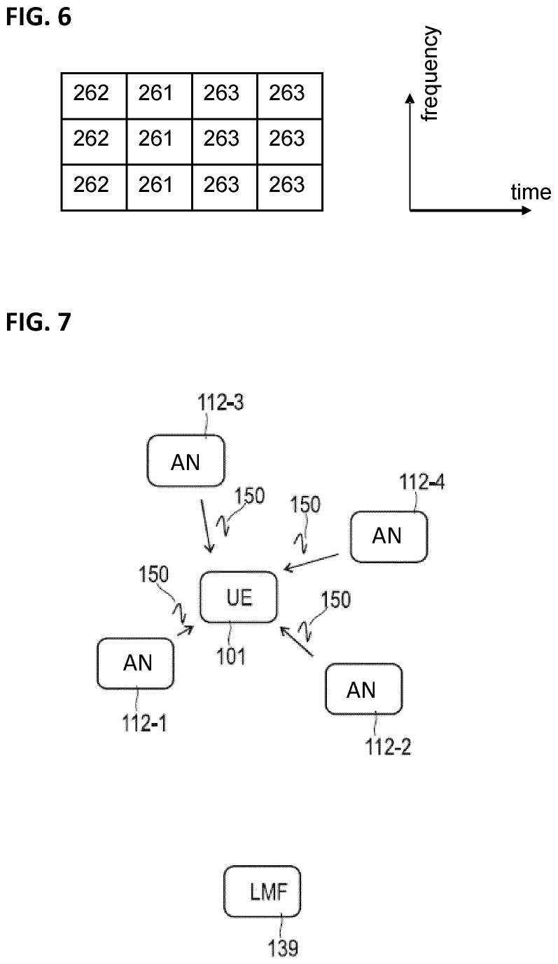

FIG. 6 illustrates aspects with respect to channels 261-263 implemented on the wireless link 114. The wireless link 114 implements a plurality of channels 261-263. The resources of the channels 261-263 are offset from each other, e.g., in frequency domain and/or time domain, in accordance with a respective resource mapping. The resources may be defined in a time-frequency grid defined by the symbols and subcarriers of the OFDM modulation of the carrier.

A first channel 261 may carry PRSs.

A second channel 262 may carry Layer 1 (PHY layer) control messages. Such control messages may be parsed by processes implemented natively on Layer 1. Thus, higher-NAS may not be involved in communication of such control messages on Layer 1. This generally reduces latency, e.g., when compared to channels that carry higher-layer control messages. Scheduling information for PDSCH may be communicated on the channel 262. Signals on the channel 262 may constitute an interruption event (Cf. TAB. 1). A specific an interruption event of the interruption events E1-E5 shown in TAB. 1 may be indicated, e.g., by communicating a respective pointer, such as corresponding interruption event index E1-E5.

Further, a third channel 263 is associated with payload messages carrying higher-layer user-plane data packets associated with a given service implemented by the UE 101 and the BS 112 (payload channel 263). The channel 263 may implement PUSCH or PDSCH. User-data messages may be transmitted via the payload channel 263. For instance, RRC messages or control messages of the PP may be communicated. Generally, more data can be accommodated in such higher-layer messages; on the other hand, since a plurality of functions on different layers of a transmission protocol stack are involved, typically, the latency required for communicating such RRC messages, etc. is comparably large.

For example, a configuration of BWPs used for PRS transmission may be included in the control messages of the PP. For instance, an interruption event of the interruption events E1-E5 shown in TAB. 1 may be communicated on the third channel 263.

FIG. 7 schematically illustrates aspects with respect to DL positioning techniques for a target UE 101 to be positioned. Multiple ANs 112-1-112-4 transmit DL PRSs 150 and the UE 101 receives the PRSs 150. Herein, the ANs 112-1-112-4 may be multiple base stations (BSs), such as, eNBs, gNBs, or TRPs (Transmission and Reception Points). Then, the UE 101 can participate in positioning, for example participating in the positioning measurement. This can include determining one or more receive properties of the PRSs 150, determining a TOA (time of arrival) of the PRSs 150, determining a TDOA (time difference of arrival) of the PRSs 150, determining an AoD (Angle of Departure) of the PRSs 150, and/or performing multilateration and/or multiangulation based on the TDOA (in the case of UE-based positioning). At least some of these tasks can also be performed by the LMF 139 or, more generally, an LS. LMF performs multilateration and/or multiangulation based on the received positioning measurement (in the case of UE-assisted positioning).

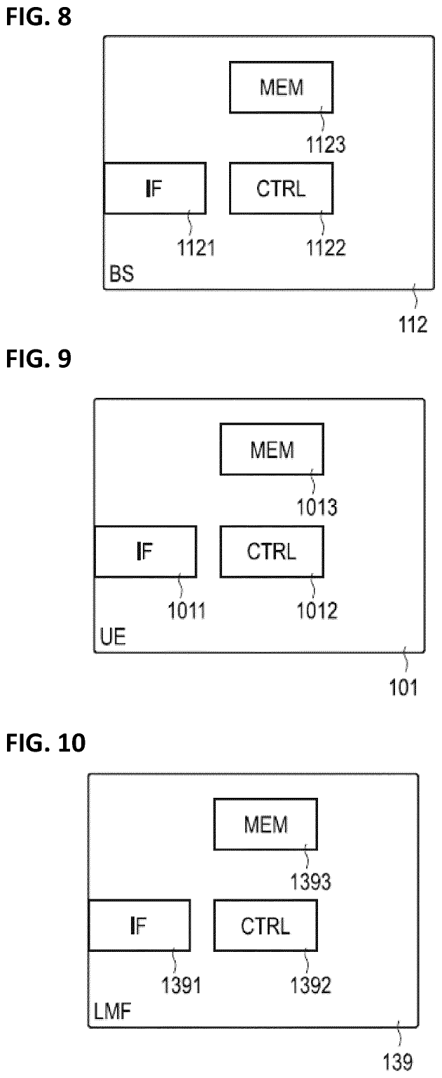

FIG. 8 schematically illustrates the AN/BS 112. For example, the ANs 112-1-112-4 could be configured accordingly. The AN/BS 112 includes an interface 1121. For example, the interface 1121 may include an analog front end and a digital front end. The interface 1121 can support multiple signal designs, e.g., different modulation schemes, coding schemes, modulation numerologies, and/or multiplexing schemes, etc. Multiple BWPs are supported. The BS 112 further includes control circuitry 1122, e.g., implemented by means of one or more processors and software. For example, program code to be executed by the control circuitry 1122 may be stored in a non-volatile memory 1123. In the various examples disclosed herein, various functionality may be implemented by the control circuitry 1122, e.g.: transmitting PRSs; transmitting a signal causing an interruption event, e.g., one of the interruption events E1-E5 shown in TAB. 1 during a positioning measurement period for performing a positioning measurement; transmitting a request for resuming monitoring for positioning signals after taking one or more actions associated with the interruption event; transmitting further signaling associated with the monitoring for the positioning signals after taking one or more actions associated with the interruption event; transmitting a list of priority levels for a plurality of candidate interruption events, such as E1-E5; providing an indication of the duration of the interruption event; receiving an indication of a positioning reference signal resource of the positioning measurement period and associated with halting of the monitoring for the positioning signals; transmitting a configuration indicative of a plurality of candidate interruption events, such as E1-E5; etc. The AN/BS 112 may also communicate with the LMF 139. For example, the AN/BS 112 may provide PRS configurations to the LMF 139, receive positioning requests from the LMF 139 and forward the positioning requests to the UE 101. The AN/BS 112 may receive assistance information from the LMF 139. Communication/signaling between the AN/BS 112 and the LMF 139 may be implemented according to 3GPP TS 36.305 version 16.3.0 Release 16, Section 6.5: Signaling between an E-SMLC and eNode B.

FIG. 9 schematically illustrates the UE 101. The UE 101 includes an interface 1011. For example, the interface 1011 may include an analog front end and a digital front end. The UE 101 further includes control circuitry 1012, e.g., implemented by means of one or more processors and software. The control circuitry 1012 may also be at least partly implemented in hardware. For example, program code to be executed by the control circuitry 1012 may be stored in a non-volatile memory 1013. In the various examples disclosed herein, various functionality may be implemented by the control circuitry 1012, e.g.: establishing a positioning measurement period for performing a positioning measurement; in the positioning measurement period, monitoring for positioning signals transmitted by the cellular network, e.g., serving and neighboring BSs; during the positioning measurement period, detecting an interruption event, such as reception of an interruption signal and/or one of the interruption events E1-E5 of TAB. 1; in response to the interruption event, halting the monitoring for the positioning signals and taking one or more actions associated with the interruption event; temporarily suspending the monitoring for the positioning signals in response to the interruption event and resuming the monitoring for the positioning signals after taking one or more actions associated with the interruption event; in response to the interruption event, aborting the monitoring for the positioning signals and performing a further (new) positioning measurement after taking one or more actions associated with the interruption event; providing a partial measurement report comprising positioning data of the positioning measurement acquired until the aborting; determining the positioning measurement, e.g., including determining TOAs of the PRSs, determining TDOA, multilateration and/or multiangulation. The latency, especially the physical layer latency incurred in performing the positioning measurement can be adjusted by using a positioning measurement period outside of an MG. In addition, when an interruption event occurs during the positioning measurement period, the UE can adaptively perform appropriate operations with respect to the positioning measurement in response to the interruption event and after taking one or more actions associated with the interruption event, to mitigate positioning latency and/or positioning accuracy caused by the interruption event. As such, the positioning latency can be balanced against the positioning accuracy. The UE 101 may communicate with the LMF 139 according to 3GPP TS 36.305 version 16.3.0 Release 16, Section 6.4: Signaling between an E-SMLC and UE.

FIG. 10 schematically illustrates an LS implemented, in the example of FIG. 10, by the LMF 139. The LMF 139 includes an interface 1391 for communicating with other nodes of the CN 115 or with the RAN 111 of the cellular network 100. The LMF 139 further includes control circuitry 1392, e.g., implemented by means of one or more processors and software. For example, program code to be executed by the control circuitry 1392 may be stored in a non-volatile memory 1393. In the various examples disclosed herein, various functionality may be implemented by the control circuitry 1392, e.g.: establishing a positioning measurement period for performing the positioning measurement; establishing a position estimate of the UE, e.g., including determining TOAs of the PRSs, determining TDOA, multilateration and/or multiangulation; determining a priority of a positioning measurement; etc.

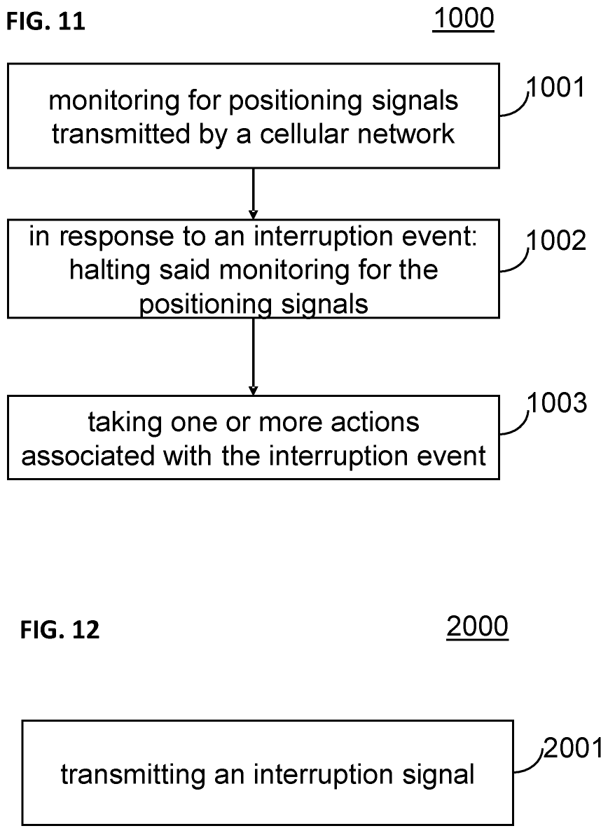

FIG. 11 is a flowchart of a method 1000 according to various examples. The method 1000 can be executed by a UE connected to a communication network, e.g., by the UE 101 of the cellular network 100 (cf. FIG. 5). For example, the method 1000 may be executed by the control circuitry 2002 of the UE 101 upon loading program code from the memory 2003 (cf. FIG. 9). Details of the method 1000 will be described below.

At box 1001, during a positioning measurement period for performing a positioning measurement, the UE monitors for positioning signals transmitted by a cellular network 100, i.e., the UE attempts to receive positioning signals on respective time-frequency resources and may perform positioning measurements based on the received positioning signals.

At box 1002, in response to an interruption event 500, the UE halts said monitoring for the positioning signals. This means the UE may temporarily suspend or abort said monitoring. This means that the positioning measurement is halted.

At box 1003, in response to said halting of the monitoring, the UE takes one or more actions associated with the interruption event.

For example, the interruption event 500 may comprise at least one of reception of an interruption signal from the cellular network, or reception of signaling from the cellular network to switch a bandwidth part of a carrier, performing a bandwidth part switching, reception of system information from the cellular network, reception of a reference signal from the cellular network, and reception of high-priority application data from the cellular network, i.e., at least one of the interruption events E1-E5 illustrated in TAB. 1.

According to various examples, said halting of said monitoring for the positioning signals comprises temporarily suspending said monitoring for the positioning signals before said taking one or more actions associated with the interruption event. For example, the one or more actions associated with the interruption event may comprise actions illustrated in TAB. 3.

Optionally or additionally, the method 1000 may further comprise resuming said monitoring for the positioning signals after said taking one or more actions associated with the interruption event 500. For example, said resuming of said monitoring for the positioning signals may be in response to receiving a respective request from the cellular network, e.g., from a serving BS or an LS. For example, the request may be carried by PDCCH or higher layer carried by PDSCH. Alternatively or optionally, said resuming of said monitoring for the positioning signals may in response to a determination that a duration T3 of the interruption event 500 has been elapsed. A resume timer—that may be preconfigured—may be used.

Optionally or additionally, the method 1000 may further comprise receiving further signaling, from the cellular network 100, associated with said monitoring for the positioning signals after said taking one or more actions associated with the interruption event 500. For example, the further signaling may indicate a configuration of a new positioning measurement period, such as t6-t5 shown in FIG. 4, and said resuming of said monitoring for the positioning signals may be performed in the new positioning measurement period t6-t5. Alternatively or optionally, the further signaling may indicate a PRS resource index and/or a time point starting from which said resuming of said monitoring for the positioning signals may be performed. Additionally or optionally, the further signaling may indicate a count of PRS resources and said resuming of said monitoring for the positioning signals may be performed using PRS resources indicated by the count.

According to various examples, said halting of said monitoring for the positioning signals may comprise aborting said monitoring for the positioning signals. Additionally or optionally, the method 1000 may further comprise in response to said aborting of said monitoring for the positioning signals, discarding positioning data of the positioning measurement acquired until said aborting, i.e., within the time duration T1 shown in FIG. 4. Optionally or additionally, the method 1000 may further comprise performing a further/new positioning measurement after said taking one or more actions associated with the interruption event. For example, the one or more actions associated with the interruption event may be performed within the duration T3 of the interruption event 500 and the further/new positioning measurement may be performed within a further/new positioning measurement period after t5, e.g., within the time duration t6-t5, cf. FIG. 4.

Optionally or additionally, the method 1000 may further comprise providing, to the cellular network 100, a partial measurement report comprising positioning data of the positioning measurement acquired until said aborting, i.e., acquired within the time duration T1 of FIG. 4.

According to various examples, the method 1000 may further comprise performing a quality evaluation of positioning data of the positioning measurement acquired until said aborting, and depending on a result of the quality evaluation, discarding the positioning data of the positioning measurement acquired until said aborting or providing, to the cellular network 100, the positioning data. The UE 101 may have received multiple PRS resources prior to the interruption event 500. Hence, the UE 101 can obtain multiple positioning measurement results, i.e., positioning data of the positioning measurement. Subsequently, the UE 101 can also evaluate the quality of each or at least one positioning measurement result. For example, the quality of TDOA measurement, RSRP level, and/or the confident level of LOS component. In further example, if the UE 101 has obtained at least one positioning measurement result, i.e., positioning data of the positioning measurement, (prior to the interruption event) with a high quality (e.g. LOS component, high RSRP), for example, above a predefined threshold, then the UE 101 can report, to the cellular network 100, a partial measurement report of the positioning measurement comprising at least a (selected) part of the positioning data of the positioning measurement acquired until said aborting. In contrast, if the UE 101 may be unable to obtain a good quality, e.g., below the predefined threshold, positioning measurement (e.g. NLOS component, low RSRP) then the UE 101 may discard the positioning data.

According to various examples, the method 1000 may further comprise performing a threshold comparison between a measure of a fraction of the positioning measurement period elapsed until halting (e.g., including temporarily suspending and aborting) and a predefined threshold, e.g., 50% or 75%; and, depending on a result of the threshold comparison, discarding positioning data of the positioning measurement acquired until the aborting, i.e., acquired within T1, or providing, to the cellular network, the positioning data. The measure of a fraction of the positioning measurement period elapsed until halting may be related to time or to the number of PRS resources. For example, as shown in FIG. 4, the measure of a fraction of the positioning measurement period elapsed until halting may comprise T1/T and/or (the total number of the PRS resources 501-505 within the time duration T1=5)/(the total number of the PRS resources 501-507 within the time duration T=7), which equals to 5/7. Similarly, the threshold may be in terms of a relative fraction of positioning reference signal resources of the positioning measurement period, e.g., 50% or 75%, or is in terms of an absolute number of the positioning reference signal resources, e.g., 5 or 7. The threshold may be configured by the cellular network 100, e.g., a serving BS or an LS.

As a general rule, said halting of said monitoring is selectively executed depending on a priority level of the interruption event, e.g., as illustrated in TAB. 1. If the priority level of the interruption event is higher than that of the positioning measurement, e.g., “2” (this priority level of the positioning measurement may be determined by the LS, e.g., the LMF 139), in response to an interruption event of either E1 or E2 in the example of TAB. 1, said halting of said monitoring is executed. Otherwise, in response to an interruption event of any one of E3-E5 in TAB. 1, said halting of said monitoring will not be executed, i.e., the positioning measurement will not be interrupted.

Optionally or additionally, the method 1000 may further comprise obtaining, from the cellular network, a list of priority levels for a plurality of candidate interruption events, the plurality of candidate interruption events comprising the interruption event. The interruption event may comprise a preconfigured priority level as shown in TAB. 1. The preconfigured/predefined priority level may be based on a communication protocol, i.e., the priority level shown in TAB. 1 may be preconfigured/predefined in the communication protocol.

According to various examples, the method 1000 may further comprise determining a duration T3 of the interruption event 500. For example, said determining of the duration T3 of the interruption event 500 may comprise receiving, from the cellular network 100, an indication of the duration T3 of the interruption event 500, e.g., according to BWP switch delay defined by 3GPP technical specification. Alternatively or optionally, said determining of the duration T3 of the interruption event 500 may comprise retrieving, from a memory 1013 of the wireless communication device 101, the duration T3 of the interruption event 500. The durations could be predefined in the communications protocol or signaled by the network.

As a general, said halting of said monitoring is selectively executed depending the duration of the interruption event.

Additionally or optionally, the method 1000 further comprises aborting the positioning measurement or temporarily suspending the positioning measurement depending on the duration of the interruption event. The method 1000 may further comprise resuming said monitoring for the positioning signals during a further positioning measurement period (e.g., t6-t5 in FIG. 4) after the interruption event at a further positioning reference signal resource.

According to various examples, the method 1000 may further comprise providing, to the cellular network 100, an indication of a positioning reference signal resource 505 of the positioning measurement period and associated with said halting of said monitoring for the positioning signals. I.e., it would be possible to signal the last monitored resource. Thereby, the network may be able to judge a reliability of the positioning measurement.

Additionally or optionally, the method 1000 may further comprise receiving, from the cellular network, a request for resuming said monitoring, and the request for resuming said monitoring comprises the indication of the further positioning reference signal resource. Thereby, the cellular network can selectively request the UE to continue the positioning measurement. This may depend, e.g., on a reliability of the unfinished positioning measurement, a priority of the positioning measurement, etc.

According to various examples, the method 1000 may further comprise receiving, from the cellular network, a configuration of the one or more actions associated with the interruption event. The network can thereby pre-configured the actions to be taken (or to be omitted) by the UE in response to the interruption event. Mitigation measures could be specified, e.g., whether or not a partial measurement report is to be transmitted or whether a positioning measurement is to be resumed on a new active BWP upon switching BWPs.

Additionally or optionally, the interruption event may comprise an interruption signal received from the cellular network, and the configuration and the interruption event may be jointly received.

This means that along with an interruption signal—e.g., a command to switch BWPs or another reference signal, cf. TAB. 1—it would be possible to provide the configuration of the one or more actions to take. Thus, a pre-configuration is not required, but on-the-spot decision making is possible.

Optionally or additionally, the method 1000 may further comprise receiving, from the cellular network 100, a positioning measurement request to perform the positioning measurement, and the positioning measurement request may be indicative of the one or more actions associated with the interruption event, and/or at least one parameter of the positioning measurement.

Optionally or additionally, the method 1000 may further comprise receiving, from the cellular network, a configuration indicative of a plurality of candidate interruption events, the plurality of candidate interruption events comprising the interruption event. This means that the network can indicate the possible interruption events; the UE can then detect the interruption events locally, i.e., without specific involvement of the network.

Optionally or additionally, the method 1000 may further comprise providing, to the cellular network a partial measurement report of the positioning measurement comprising positioning data of the positioning measurement acquired until said halting. The partial measurement report may comprise a predefined number of positioning data determined based on reception of the positioning signals until said halting.

Optionally or additionally, the method 1000 may further comprise providing, to the cellular network, an indication of at least one of the following: said halting of the positioning measurement, the interruption event, a length of the positioning measurement period that is elapsed until said halting, a count of the positioning signals that the wireless communication device received until said halting, and/or a positioning reference signal resource of the positioning measurement period and associated with said halting of said monitoring for the positioning signals. All such information can be helpful in judging a reliability of a partial measurement report and/or in making a decision on whether to resume a positioning measurement.

According to various examples, said halting of the positioning measurement may comprise at least one of temporarily suspending the positioning measurement and resuming in a period of time, aborting the positioning measurement, and providing a partial measurement report of the positioning measurement.

FIG. 12 is a flowchart of a method 2000 according to various examples. The method 2000 can be executed by a node of a communication network, e.g., by a node of the cellular network 100 (cf. FIG. 5). For example, the method 2000 could be implemented by a BS 112, 112-1-112-4 of the RAN 111; however, it would also be possible that the method 2000 is implemented by the LMF 139 or another node of the cellular network 100. For example, the method 2000 may be executed by the control circuitry 1122 of the BS 112 or the control circuitry 1392 of the LMF 139 upon loading program code from the memory 1123 or 1393, respectively. The method 2000 corresponds a scenario in which the interruption event are obtained from a node of the network 100. Details of the method 2000 will be described below.

At box 2001, during a positioning measurement period for performing a positioning measurement by a wireless communication device 101, transmitting an interruption signal to the wireless communication device 101. The interruption signal causes an interruption event at the UE.

The interruption event enables the wireless communication to halt monitoring for positioning signals transmitted by a cellular network and to take one or more actions associated with the interruption event.

The techniques of methods 1000 and 2000 thus support positioning measurement with low latency with the presence of an interruption event—i.e., the latency, especially the physical layer latency incurred in performing the positioning measurement can be adjusted by using a positioning measurement period outside of an MG. In addition, when an interruption event happens during the positioning measurement period, the UE can adaptively perform appropriate operations with respect to the positioning measurement in response to the interruption event and after taking one or more actions associated with the interruption event, to mitigate positioning latency and/or positioning accuracy caused by the interruption event. As such, the positioning latency can be balanced against the positioning accuracy.

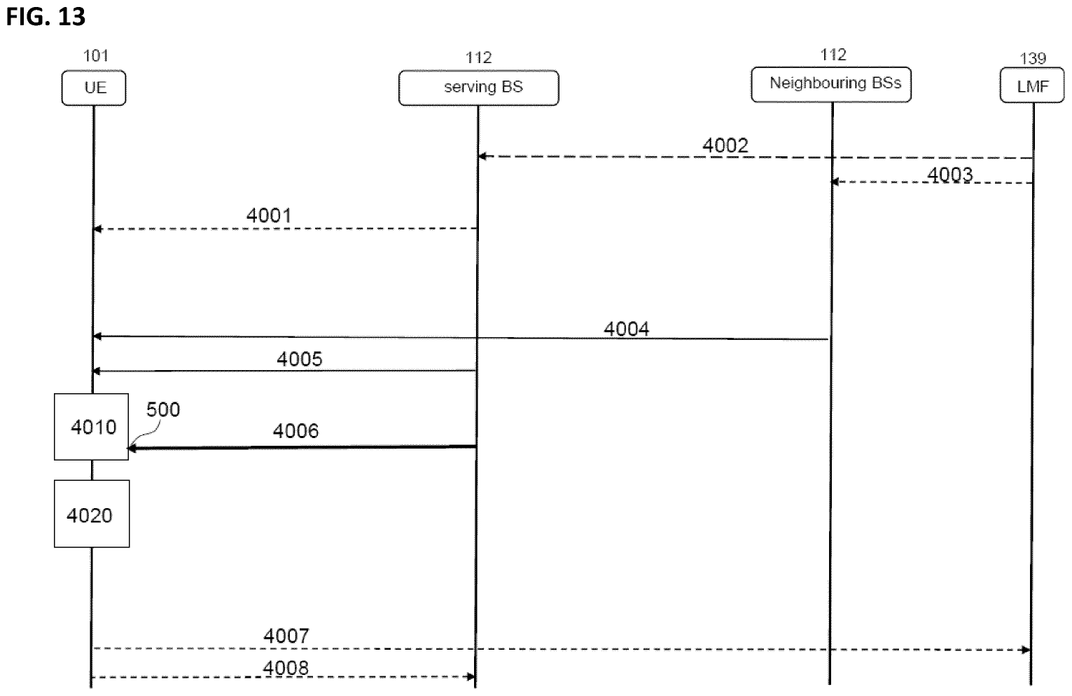

Next, details with respect to signaling between the various participating entities—e.g., the BS 112 including serving BS and neighboring BSs, the UE 101, and the LMF 139—are explained in connection with FIG. 13.

FIG. 13 is a signaling flowchart illustrating communication between the BS 112, i.e., the serving BS and the neighboring BSs, of the RAN 111, the LMF 139 and the UE 101. For example, the signaling of FIG. 13 could implement the methods 1000 and 2000.

Alternative operations are indicated by using dashed lines. The reference signs starting with 40—may indicate signaling or operations, e.g., signaling (4001-4008) communicating in-between any two of the UE 101, the LMF 139, and the serving and neighboring BSs 112, operations 4010 and 4020 performed at the UE 101.

The UE 101 may optionally receive a request to provide a low-latency positioning measurement result. The request may be received from the serving BS 112 at 4001. Additionally or optionally, the serving BS may receive the request from the LMF 139 at 4002 and forward the request to the UE 101 at 4001. The request transmitted from the BS 112 or the LMF 139 may be received from applications running on a server connected to the cellular network, such as a cloud computing server or an edge computing server. Additionally or optionally, the LMF 139 may jointly transmit the request to both the serving BS and the neighboring BSs to configure both to send PRSs respectively at 4005 and at 4004 in a positioning measurement period, such as T of FIG. 4.

At 4010, the UE 101 performs a positioning measurement by monitoring for positioning signals transmitted by the serving BS 112 and the neighboring BSs 112 during the positioning measurement period T (or t6-t1) shown in FIG. 4.

The UE 101 then detects an interruption event 500, here reception of an interruption signal 4006 (cf. FIG. 4) from the serving BS 112; the UE 101, in response to the interruption event 500, halts monitoring for the positioning signals. The UE 101 then takes one or more actions associated with the interruption event, such as those illustrated in TAB. 3. The halting the monitoring for the positioning signals may comprise: i) temporarily suspending the monitoring for the positioning signals; ii) aborting the monitoring for the positioning signals; iii) aborting the monitoring for the positioning signals, and discarding positioning data of the positioning measurement acquired until the aborting; iv) aborting the monitoring for the positioning signals, providing, to the cellular network, a partial measurement report comprising positioning data of the positioning measurement acquired until the aborting, and discarding positioning data of the positioning measurement acquired until the aborting.

After taking one or more actions associated with the interruption event 500 (cf. FIG. 4), at 4020, the UE may i) resume the monitoring for the positioning signals; ii) perform a further (new) positioning measurement.

Herein, the operations, at 4010 and/or 4020, performed by the UE 101 may be consistent with those described in connection with FIGS. 4, 11, and 12.

Optionally or additionally, at 4008 and 4007, the UE 101 may provide a (partial) measurement report comprising positioning data of the positioning measurement acquired at 4010 and/or 4020, to the serving BS and to the LMF 139, respectively.

Summarizing, various techniques disclosed herein support positioning measurement with low latency—i.e., the latency, especially the physical layer latency incurred in performing the positioning measurement can be adjusted by using a positioning measurement period outside of an MG. In addition, when an interruption event happens during the positioning measurement period, the UE can adaptively perform appropriate operations with respect to the positioning measurement in response to the interruption event and after taking one or more actions associated with the interruption event, to mitigate positioning latency and/or positioning accuracy caused by the interruption event. As such, the positioning latency can be balanced against the positioning accuracy.

Although the disclosure has been shown and described with respect to certain preferred examples, equivalents and modifications will occur to others skilled in the art upon the reading and understanding of the specification. The present disclosure includes all such equivalents and modifications and is limited only by the scope of the appended claims.

For instance, various examples have been described in which an LS implements an LMF to facilitate positioning of a UE. The techniques described herein can also be used in connection with other implementations of the LS.

For further illustration, various examples have been described in connection with implementations of BSs by ANs/BSs of a cellular network, the techniques can also be applied to other types of communication systems.

Still further, while various examples have been described in connection with OTDOA or TDOA positioning, other kinds and types of positioning techniques using PRSs may benefit from the techniques described herein. For example, the techniques described herein can also be applied to other measurement method, such as signal strength measurements (e.g., Reference Signal Receive Power, RSRP; or Signal to Interference plus Noise Ratio, SINR).

For still further illustration, various examples have been disclosed in connection with DL positioning, but may also be applied to UL positioning.

1. A method of operating a wireless communication device, the method comprising:
during a positioning measurement period for performing a positioning measurement: monitoring for positioning signals transmitted by a cellular network and in response to an interruption event halting said monitoring for the positioning signals, and
in response to said halting of the monitoring: taking one or more actions associated with the interruption event.

2. The method of claim 1, wherein the interruption event comprises reception of signaling from the cellular network to switch a bandwidth part of a carrier.

3. The method of claim 1, wherein the interruption event comprises performing a bandwidth part switching.

4. The method of claim 1, wherein the interruption event comprises reception of system information from the cellular network.

5. The method of claim 1, wherein the interruption event comprises reception of a reference signal from the cellular network.

6. The method of claim 1, wherein the interruption event comprises reception of high-priority application data from the cellular network.

7. The method of claim 1, wherein said halting of said monitoring for the positioning signals comprises temporarily suspending said monitoring for the positioning signals before said taking one or more actions associated with the interruption event.

8. The method of claim 7, further comprising
resuming said monitoring for the positioning signals after said taking one or more actions associated with the interruption event.

9. The method of claim 8, wherein said resuming of said monitoring for the positioning signals is in response to receiving a respective request from the cellular network.

10. The method of claim 7, further comprising
receiving further signaling, from the cellular network, associated with said monitoring for the positioning signals after said taking one or more actions associated with the interruption event.

11. The method of claim 1, wherein said halting of said monitoring for the positioning signals comprises aborting said monitoring for the positioning signals.

12. The method of claim 11, further comprising
in response to said aborting of said monitoring for the positioning signals, discarding positioning data of the positioning measurement acquired until said aborting.

13. The method of claim 11, or 12, further comprising
performing a further positioning measurement after said taking one or more actions associated with the interruption event.

14. The method of claim 11 further comprising
providing, to the cellular network, a partial measurement report comprising positioning data of the positioning measurement acquired until said aborting.

15. The method of claim 1, further comprising:
performing a threshold comparison between a measure of a fraction of the positioning measurement period elapsed until said halting and a threshold, and
depending on a result of the threshold comparison, discarding positioning data of the positioning measurement acquired until said aborting or providing, to the cellular network, the positioning data.

16. The method of claim 15, wherein the threshold is configured by the cellular network.

17. The method of claim 15, wherein the threshold is in terms of a relative fraction of positioning reference signal resources of the positioning measurement period or is in terms of an absolute number of the positioning reference signal resources.

18. The method of claim 1, wherein said halting of said monitoring is selectively executed depending on a priority level of the interruption event.

19-36. (canceled)

37. The method of claim 1, further comprising:
performing a quality evaluation of positioning data of the positioning measurement acquired until said aborting, and
depending on a result of the quality evaluation, discarding the positioning data of the positioning measurement acquired until said aborting or providing, to the cellular network, the positioning data.

38. A method of operating a node of a cellular network, the method comprising:
during a positioning measurement period for performing a positioning measurement by a wireless communication device, transmitting an interruption signal to the wireless communication device, wherein the interruption signal causes an interruption event at the wireless communication device, and the interruption event causes the wireless communication device to halt monitoring for positioning signals transmitted by the cellular network.

39-69. (canceled)
